(19) United States
(12) Patent Application Publication
(10) Pub. No.: US 2014/0149087 A1
(43) Pub. Date: May 29, 2014

(54) DETECTING THE POTENTIAL FOR INSTABILITIES IN A TWO-PHASE FLUID SYSTEM

(71) Applicant: SCHLUMBERGER TECHNOLOGY CORPORATION, Sugar Land, TX (US)

(72) Inventor: Cedric Fraces, Sugar Land, TX (US)

(73) Assignee: SCHLUMBERGER TECHNOLOGY CORPORATION, Sugar Land, TX (US)

(21) Appl. No.: 13/689,134

(22) Filed: Nov. 29, 2012

(51) Int. Cl. G06F 17/50

(52) U.S. Cl. CPC G06F 17/5009
USPC 703/2

(57) ABSTRACT

Methods, apparatus, and computer-readable media are provided, including a computer-implemented method for detecting a potential for dynamic instability in a fluid system. The method includes generating a first transfer function in a frequency domain. The first transfer function relates a pressure drop perturbation to a fluid velocity perturbation in a single-phase flow section of the fluid system. The method further includes generating a second transfer function in the frequency domain. The second transfer function relates a pressure drop perturbation to a fluid velocity perturbation in a multiphase flow section of the fluid system. The method also includes determining, using a processor, that the fluid system is potentially unstable using a combination of the first and second transfer functions.

### TECHNICAL FIELD

The present disclosure relates to modeling instabilities in a fluid system.

### BACKGROUND

Instabilities in fluid systems can present challenges; for example, system instability can damage system components and/or result in sub-optimal fluid flow characteristics. Accordingly, fluid systems are often analyzed to determine whether, and under what conditions, the systems become unstable. Instabilities may be static or dynamic, and there are several variants of each type.

Static instability analysis begins by considering that the system tends to operate at an equilibrium point. When a perturbation is introduced (i.e., a change in one or more operating variables, such as pressure or fluid velocity), if the system reacts by returning to the same equilibrium point, the system is considered stable. On the other hand, if the system reacts to the perturbation by moving the system to a new equilibrium point, the system is considered unstable at the first equilibrium condition. Such static instabilities can be simplistically conceptualized as a pendulum that is free to rotate 360 degrees around a pivot. If the pendulum is balanced extending upwards, a small perturbation can send the pendulum swinging toward the lowest point, and thus the system is unstable. If the pendulum is at equilibrium at the bottom, a small perturbation may move the pendulum, but the pendulum returns to the bottom position without needing external correction. Accordingly, the system is statically stable in the latter case.

Dynamic instabilities, on the other hand, operate in a transient state, and can take the form of density wave oscillations, pressure propagation, condensation-induced water-hammer, acoustic instabilities, and others. In dynamic instability analysis, a system response to a perturbation (e.g., a periodic perturbation) is considered. If the system response tends to cancel out the perturbation, the system is stable. On the other hand, if the system builds upon the perturbation, such that the response becomes self-sustaining, then the system is unstable. Dynamic instabilities are generally more complex and thus more challenging to account for in large systems.

Further, dynamic system instabilities can appear in various petroleum production applications, in both on-shore and offshore fields. Examples of petroleum applications where dynamic instabilities are observed are in casing heading, artificial lift, and in annulus accumulation. Such instabilities can result in suboptimal production and can lead to hazardous situations and abnormal mechanical stress and fatigue of the installations.

As such, in these and other applications, it is often desirable to model the fluid systems, and predict and avoid instabilities. A variety of methods have been employed to model fluid systems at every time, such that unstable conditions can be predicted. Such methods, however, are generally computation intensive, requiring mobilization of a large amount of computing resources to prepare, grid, tune, etc., a model and prepare a numerical solution. Further, in some applications, it is common for the characteristics of the fluid system to change, for example, when additional hardware (elbows, restrictions, lengths of pipe, etc.) are added or removed. In traditional modeling schemes, each such physical change of the fluid system would require a new model and a new solution, further occupying computing resources.

What is needed are improved systems and methods for detecting the potential for dynamic instabilities in a fluid system.

### SUMMARY

Embodiments of the disclosure may provide a computer-implemented method for detecting a potential for dynamic instability in a fluid system. The method includes generating a first transfer function in a frequency domain. The first transfer function relates a pressure drop perturbation to a fluid velocity perturbation in a single-phase flow section of the fluid system. The method further includes generating a second transfer function in the frequency domain. The second transfer function relates a pressure drop perturbation to a fluid velocity perturbation in a multiphase flow section of the fluid system. The method also includes determining, using a processor, that the fluid system is potentially unstable using a combination of the first and second transfer functions.

Embodiments of the disclosure may further provide a computing system for modeling a fluid system having a single-phase flow section and a multiphase flow section. The computing system includes one or more processors, and one or more computer readable media containing instructions that, when executed by the one or more processors, cause the system to perform operations. The operations include generating a first transfer function in a frequency domain. The first transfer function relates a pressure drop perturbation to a fluid velocity perturbation in a single-phase flow section of the fluid system. The operations further include generating a second transfer function in the frequency domain. The second transfer function relates a pressure drop perturbation to a fluid velocity perturbation in a multiphase flow section of the fluid system. The operations also include determining that the fluid system is potentially unstable using a combination of the first and second transfer functions.

Embodiments of the disclosure may also provide a computer-readable medium storing instructions that, when executed, are configured to cause a computing system to perform operations. The operations include collecting data for one or more variables of the fluid system. The operations also include generating a transfer function in a frequency domain using the data collected. The transfer function relates a pressure drop perturbation to a fluid velocity perturbation in the fluid system. The operations further include determining, using a processor, that the fluid system is potentially unstable using the transfer function.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a flowchart of a method for detecting a potential for dynamic instabilities in a fluid system, according to an embodiment.

FIG. 2 illustrates a schematic view of a fluid system, according to an embodiment.

FIG. 3 illustrates a plot of a stable system response at three points in time, according to an embodiment.

FIG. 4 illustrates a plot of an unstable system response at three points in time, according to an embodiment.

FIG. 5 illustrates a plot of an equation of state as compared to plots of approximations of the equation of state in a fluid system having a single-phase flow section and a multiphase flow section, according to an embodiment.

FIGS. 6A and 6B illustrate Nyquist plots of the response of the fluid system to a perturbation, according to an embodiment.

FIG. 7 illustrates a flowchart of a method for determining system stability sensitivity, which may employ one or more embodiments of the method illustrated in FIG. 1, according to an embodiment.

FIGS. 8-10 illustrate Nyquist plots for system response as part of a sensitivity analysis, according to an embodiment.

FIG. 11 illustrates a schematic view of a computing system, according to an embodiment.

### DETAILED DESCRIPTION

The following detailed description refers to the accompanying drawings. Wherever convenient, the same reference numbers are used in the drawings and the following description to refer to the same or similar parts. While several exemplary embodiments and features of the present disclosure are described herein, modifications, adaptations, and other implementations are possible, without departing from the spirit and scope of the present disclosure. Accordingly, the following detailed description does not limit the present disclosure. Instead, the proper scope of the disclosure is defined by the appended claims.

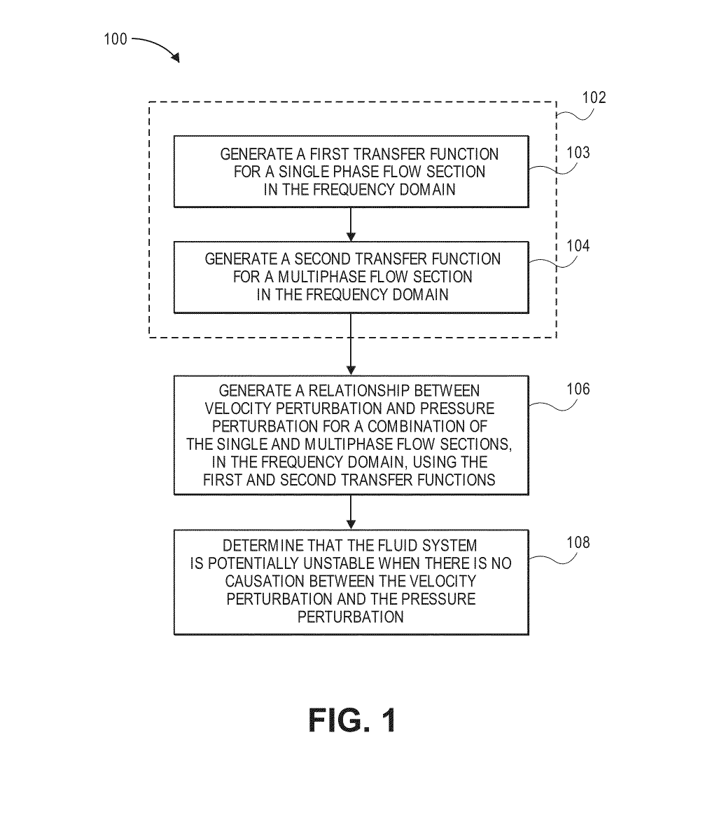

FIG. 1 illustrates a flowchart of a method 100 for detecting a potential for dynamic instabilities in a fluid system, according to an embodiment. As the term is used here, “potential for” is generally defined to mean that a necessary, rather than a sufficient, condition is met. Accordingly, if the necessary condition for instability is found, the potential exists for the system to be unstable, but it may still be stable. Further, in an embodiment, the method 100 may be employed in a fluid flow system that includes both a single-phase flow section and a multiphase flow section; however, in some situations, the flow may be substantially or entirely single or multiphase flow. For example, the fluid flow system may receive heat from an external source, such that fluid flow may begin in a supercooled, liquid phase and exit the system having been at least partially vaporized.

One example of dynamic instability is a density wave. Density waves propagate through a compressible fluid at a finite velocity; however, when the increased density of the wave reaches the outlet of the system, the pressure drop in the system as a total remains constant, and thus, as will be shown below, there is an instantaneous (or nearly instantaneous) pressure drop available throughout the system. This gap in time between the propagation of the density wave and the availability of the pressure drop can result in a density-wave instability, in which a perturbation in the system can produce density waves, which in turn produce responsive density waves in a self-sustaining fashion, resulting in system instability. In petroleum applications, such density waves can damage the petroleum producing components and/or can lead to suboptimal production.

To effectively model a potential for dynamic instability, while, for example, preserving scarce computing resources (and/or maximizing available resource), the method 100 includes generating a transfer function of a fluid flow system response to a perturbation in a frequency domain, as at 102. Such generation at 102 may include generating a first transfer function for a single-phase flow section, in the frequency domain, as at 103. For example, the first transfer function may relate an inlet velocity perturbation to a pressure perturbation response in the single-phase flow section. Further, such generation may include generating a second transfer function for a multiphase flow section, also in the frequency domain, as at 104. For example, the second transfer function may relate the inlet velocity perturbation to a pressure perturbation response in the multiphase flow section.

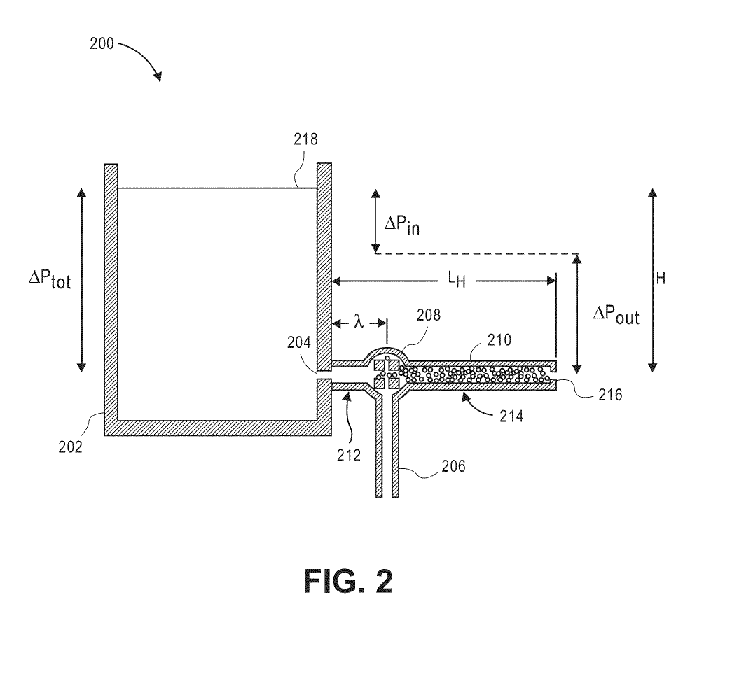

Further, generating the transfer function at 102 may proceed by modeling the fluid system conceptually. FIG. 2 illustrates a simplified schematic of a model of such a fluid system 200. As shown, the system 200 includes a liquid reservoir 202 connected with a fluid conduit 210. The system 200 further includes an inlet 204, connecting the reservoir 202 with the fluid conduit 210, and a gas inlet 206 configured to deliver gas to the fluid conduit 210, where it is mixed with liquid from the reservoir 202 at a junction 208. The gas inlet 206 may serve to model vaporization of liquid in the reservoir 202 caused by heat transfer into the fluid through the fluid conduit 210 (e.g., from the ambient environment). Accordingly, the fluid conduit 210 has a single-phase flow section 212 upstream of the junction 208 and a multiphase flow section 214 between the junction 208 and an outlet 216 of the fluid conduit 210. Furthermore, the fluid conduit 210 extends a length L_{H} from the inlet 204 to the outlet 216 along a z-axis, where z=0 at the inlet 204, z=λ at the juncture 208, and z=L_{H} at the outlet 216, as shown.

It will be appreciated that the quality of the fluid (i.e., the percentage of the fluid in gaseous state) may not remain constant in the multiphase flow section 214. For example, fluid may continue vaporizing in the multiphase flow section 214, e.g., by continued heat flux into the fluid in the fluid conduit 210 from the environment (or any other heat source). Moreover, in the illustrated conceptual system 200, the liquid is discussed in terms of water and the surrounding environment is discussed in terms of air; however, it will be readily appreciated that this is for illustrative purposes only and is but one embodiment among many contemplated. The surrounding environment may be any environment, under any pressure, for example, in a wellbore. Further, the liquid in the reservoir 202 may be any liquid at any pressure. Additionally, the liquid in the reservoir 202 need not be a single liquid, but may be a solution, combination of fluids, suspension, etc.

Turning to the physics of the conceptualized system 200, but without necessarily being limited by theory, the system 200 may be acted upon by a pressure Pₒᵤₜ at the outlet 216. The pressure Pₒᵤₜ may also act on an open, “upper” surface 218 of the liquid in the reservoir 202. The outlet pressure Pₒᵤₜ may be atmospheric or may be higher, for example, acted upon by a column of fluid, such as in a wellbore. Further, the surface 218 may further be positioned at a height H above the outlet 216, and as such, the pressure on the surface 218 may be less than Pₒᵤₜ according to the height H and the density of the fluid in the surrounding environment.

In an embodiment, the inlet 204 and the outlet 216 may be at generally the same height or level; however, it will be appreciated that this need not be the case and the outlets 204, 216 may be at different levels. In at least one embodiment, the pressure Pₒᵤₜ may be known, e.g., may be the pressure in the ambient environment at the outlet 214. Accordingly, in at least one conceptual embodiment, the pressures at the inlet 204 (Pᵢₙ) and the pressure at the surface 218 may be calculated as:

P_{surf}=Pₒᵤₜ−ρₐᵢᵣ(gH)≈Pₒᵤₜ (1)

Pᵢₙ=Pₒᵤₜ−ρₐᵢᵣ(gH)+ρ_{wat}(gH) (2)

where P_{surf} is the pressure on the surface 218, ρ_{wat} is the density of the liquid (e.g., water) in the reservoir 202, ρₐᵢᵣ is the density of the fluid in the ambient environment (e.g., air), H is the height, and g is the acceleration due to gravity.

In an embodiment, the liquid reservoir 202 may be conceptualized as being continuously filled such that the height H of the surface 218 above the outlet 216 remains constant. Further, the amount of gas injected via the gas inlet 206, which, again, may model the vaporization of liquid in the fluid conduit 210 or actually provide for the injection of gaseous flow into the fluid conduit 210, may be held constant. Accordingly, the total pressure drop may also be constant, and the sum of the pressure drops at the inlet 204 (Δpᵢₙ) and at the outlet 216 (Δpₒᵤₜ). As such, the pressure drop equations are decomposed as:

$$\begin{matrix}Δ {p}_{in} = {K}_{in} \frac{{ρ}_{l} {u}_{in}^{2}}{2} & ( 3 ) \\ Δ {p}_{out} = {K}_{out} \frac{{ρ}_{2} {u}_{out}^{2}}{2} & ( 4 )\end{matrix}$$

where Kᵢₙ is a friction coefficient characterizing the single phase liquid part of the system. It is proportional to Moody's friction factor and the inverse of gravitational acceleration g times the pipe inside diameter; ρ₁ is the density of the liquid (e.g., in the single-phase flow section 212); uᵢₙ is the velocity of the fluid at the inlet 204; Kₒᵤₜ is a friction coefficient for a two phases fluid, ρ₂ is the density of the mixed phase fluid (e.g., in the mixed phase section 214); and uₒᵤₜ is the velocity of the fluid at the outlet 216.

Further, the pressure drops Δpᵢₙ and Δpₒᵤₜ can be related to the liquid height, as:

$$\begin{matrix}{H}_{in} \frac{Δ {p}_{in}}{{ρ}_{l} g} = {K}_{in} \frac{{u}_{in}^{2}}{2 g} & ( 5 ) \\ {H}_{out} \frac{Δ {p}_{out}}{{ρ}_{2} g} = {K}_{out} \frac{{u}_{out}^{2}}{2 g} & ( 6 )\end{matrix}$$

where Hᵢₙ is the effective inlet height and Hₒᵤₜ is the effective outlet height. Further, assuming the vapor contribution to the overall density is negligible, but is substantial concerning the volume occupied, the total pressure drop ΔPₜₒₜ is expressed as:

Δpₜₒₜ=Δpᵢₙ+Δpₒᵤₜ=constant. (7)

A perturbation of the inlet velocity uᵢₙ may lead to an increase of the inlet pressure drop Δpᵢₙ. As vapor flow is constant, the mixture density ρ₂ (i.e., of fluid in the multiphase flow section 214) is modified and a wave of the modified density propagates through the conduit 210, until it reaches the outlet 216. When it reaches the outlet 214, since the pressure drop is directly proportional to the velocity of the fluid, the pressure drop at the outlet Δpₒᵤₜ increases, thereby increasing the effective outlet height Hₒᵤₜ. Thus, with the total pressure drop Δpₜₒₜ being constant, according to equation (7), an immediate (or nearly immediate) decrease of pressure drop Δpᵢₙ is observed at the inlet 204 when the density wave reaches the outlet 216. This generates a decrease of the inlet velocity uᵢₙ, as can be appreciated from equation (5). This reduction in velocity uᵢₙ results in the propagation of a new density wave in the conduit 210, in response to the first density wave reaching the outlet 216. If this periodic phenomenon of density wave and response reaches a self-sustained mode, the system 200 can be considered unstable.

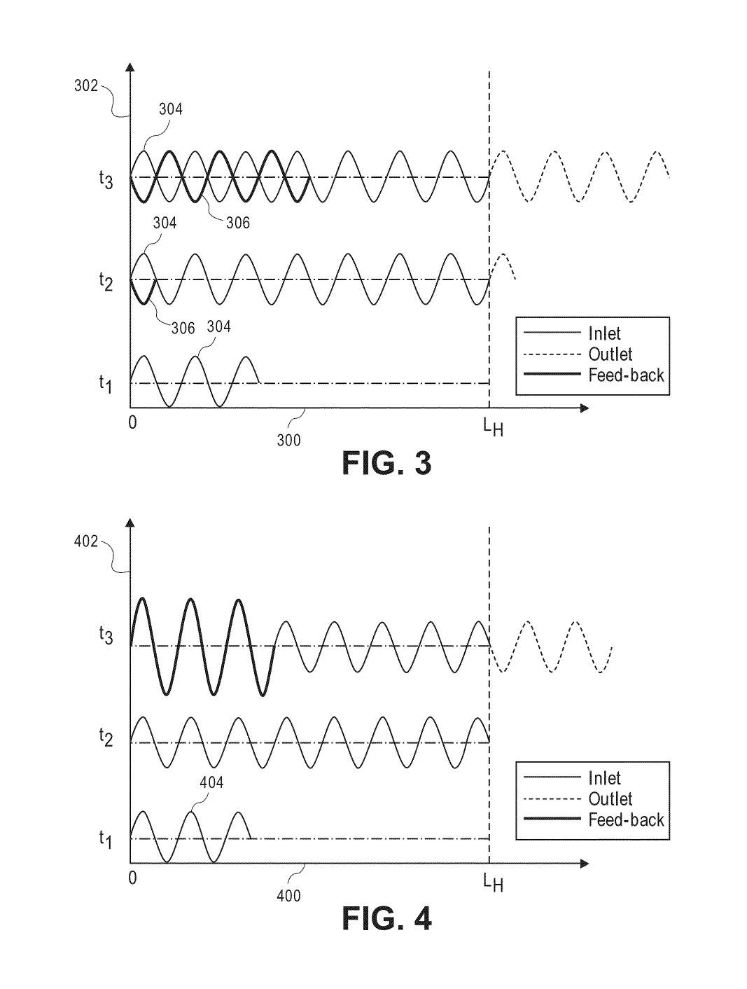

With continuing reference to FIG. 2, FIG. 3 illustrates an example of a stable system response to a perturbation. The abscise 300 of the plot represents the length of the conduit 210, from the inlet 204 at zero, to the length L_{H} at the outlet 216. The ordinate 302 represents the density at different points in time t₁, t₂, t₃. The perturbation can be a change in the inlet velocity δu. As explained above, this results in a change in density (density perturbation) δρ in the multiphase flow section 214, since the density in the single-phase (liquid) section 212 is considered incompressible. Accordingly, as shown in the representation of time t₁, a periodic velocity perturbation δu can generate a periodic density wave 304 of generally the same frequency.

The representation for time t₂ illustrates the system 200 response when the density waves 304 begin reaching the outlet 214 at the length L_{H}. As illustrated, a responsive density wave 306 is generated. In this case, the responsive wave 306 is out of phase with the density wave 304 generated by the periodic fluid velocity perturbation δu. As shown for time t₃, the responsive density wave 306 propagates through the conduit 210 as does the density wave 304. With the density waves 304, 306 being out of phase by an amount, as shown, by about 180 degrees, for example, the density waves 304, 306 tend to cancel each other out. Thus, when the periodic perturbation δu ends, responsive density waves 306 reduce in amplitude and/or stop. As such, the system 200 is stable. Further, with such cancellation of density, even if not complete, the system response will trend toward returning to the steady-state, lacking density waves, after the cessation of the perturbation δu.

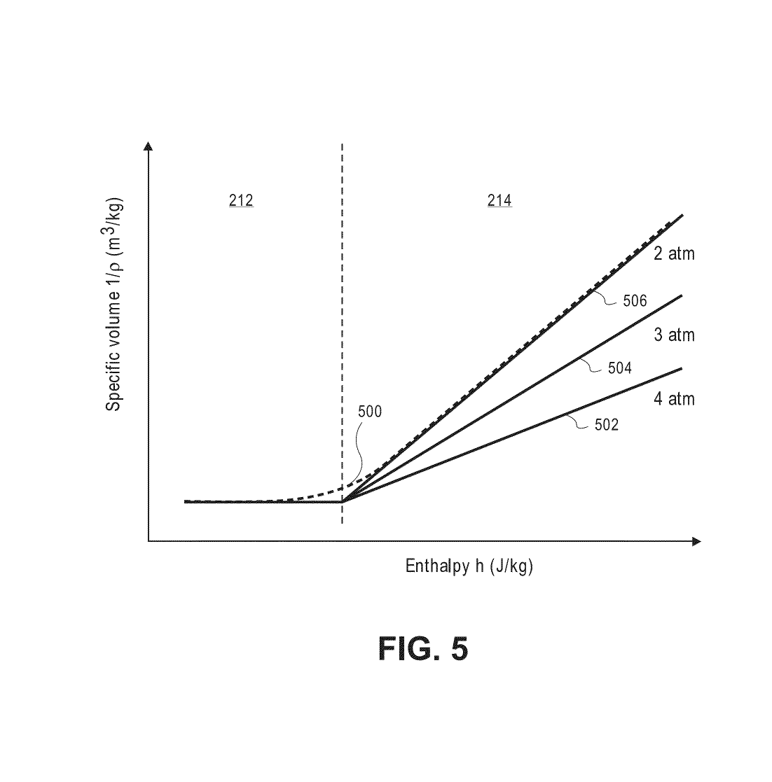

Still referring additionally to FIG. 2, FIG. 4 illustrates an example of an unstable system response to a perturbation δu. As with FIG. 3, in FIG. 4, the abscise 400 represents time, while the ordinate 402 represents the length of the fluid conduit 210. Further, at time t₁, a density wave 404 is produced by a periodic velocity perturbation δu. The density wave 404 begins propagating through the fluid conduit 210, as a function of time and at a frequency corresponding to the frequency of the velocity perturbation δu.

At time t₂, the density wave 404 extends to the outlet 216, which, as described above, results in a reduced density instantaneously, or nearly so, at the beginning of the multiphase flow section 214. However, unlike the stable response of FIG. 2, FIG. 3 illustrates the responsive density wave being in phase with the density wave 404, resulting in a combined wave 406, which may have a larger amplitude than the density wave 404, as shown.

Accordingly, the system response in FIG. 3 may be unstable, as the response to the perturbation δu may be self-sustaining. That is, when the density wave 404 reaches the outlet 216 at L_{H}, it generates a pressure response at the inlet 204, which manifests as another density wave in the multiphase flow section 212, which is in phase with the density wave 404. This cycle continues, as each density wave 404 reaching the outlet 214 generates a replacement for itself, leaving the response self-sustaining. This is an example of density wave instability.

This simplified system 200 and response, as shown in and described above with reference to FIGS. 2-4, is provided to explain how density wave instabilities can appear in flow along a pipe of length L_{H}, where a portion λ₀ to L_{H} of the length is two-phase flow. The transport time is given by the expression:

$${T}_{r} = {Tr}_{2} + {Tr}_{1} \approx {\int }_{{λ}_{0}}^{{L}_{H}} \frac{d z}{{u}_{k} ( z )} + \frac{{λ}_{0}}{{u}_{in}} \qquad ( 8 )$$

where Tᵣ is the total transport time, Tr₂ is the transport time in the multiphase flow section 214, Tr₁ is the transport time in the single-phase flow section 212, z is the position in the conduit 210 (the abscise in FIGS. 3 and 4), uᵢₙ is the inlet velocity of the liquid and uₖ(z) is the instantaneous velocity of the mixture at a given point along the conduit 210. In some cases, if the period of the perturbation function is twice the transport time in the conduit 210, the system 200 may exhibit dynamic instability.

To determine the stability conditions, considering the total pressure to be generally constant and modeling flow in one dimension in the conduit 210, the conservation of mass, energy, and momentum in the conduit 210 is modeled as:

$$\begin{matrix}\frac{\partial ρ}{\partial t} + u \frac{\partial ρ}{\partial z} + ρ \frac{\partial u}{\partial z} = 0 ( mass ) & ( 9 ) \\ \frac{\partial ρ h}{\partial t} + ρ u \frac{\partial h}{\partial z} = ϕ + \frac{\partial p}{\partial t} ( energy / enthalpy ) & ( 10 ) \\ \frac{\partial G}{\partial t} + \frac{1}{ρ} \frac{\partial {G}^{2}}{\partial z} = - \frac{\partial p}{\partial z} - \frac{f}{{D}_{H}} \frac{{G}^{2}}{2 ρ} - ρ g sin ϑ ( momentum ) & ( 11 )\end{matrix}$$

where h is the enthalpy, φ is the heat transfer rate, G is the momentum, f is the friction coefficient, and D_{H} is the inside diameter of the fluid conduit. Integrating the momentum equation (11) gives the total pressure drop Δpₜₒₜ along the conduit 210. This leaves four variables density, velocity, pressure, and enthalpy. Thus, a fourth equation is needed to provide a solution. This is the fluid equation of state, which relates density and enthalpy.

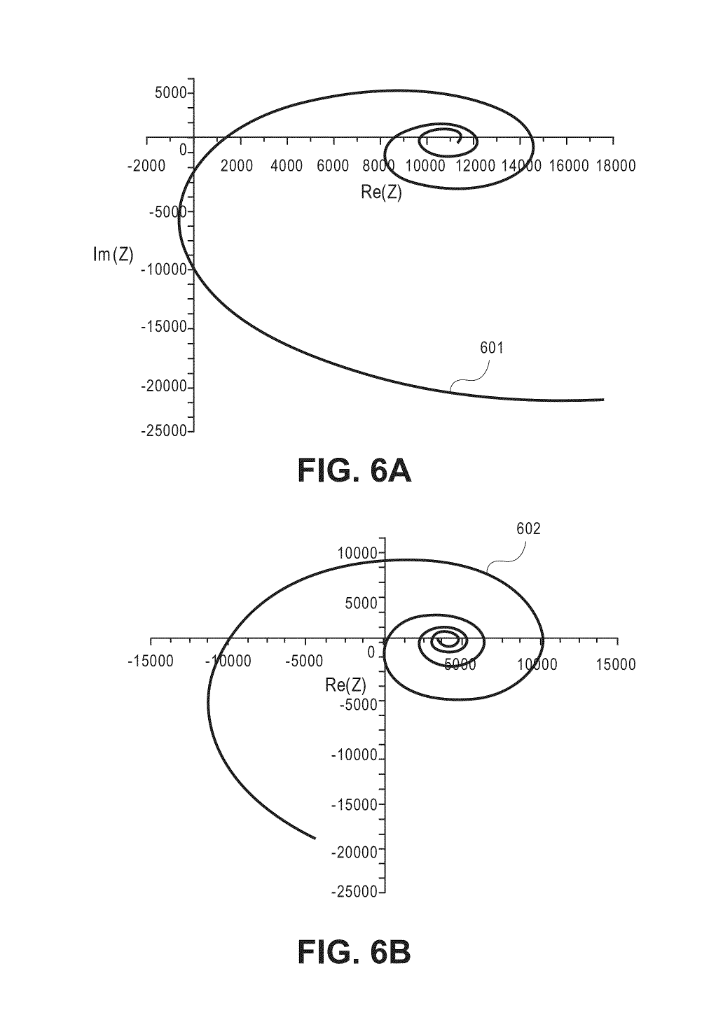

The equation of state can be modeled by choosing the two zone model, as described above for system 200, with the single-phase flow section 212 and the multiphase flow section 214 in the conduit 210, as well as considering the liquid in the single-phase flow section 212 to be incompressible (constant density). In the multiphase flow section 214, the specific volume 1/ρ₂ may be modeled as a linear function of the temperature and enthalpy. As illustrated in FIG. 5, the equation of state is plotted as line 500 against three two-zone model lines 502, 504, 506. As shown, the two-zone model may represent a sufficiently-precise approximation for the real equation of state, determining the density as a function of the enthalpy.

To determine the modeled equation of state, the next step is to establish the pressure drop. The fluid enters the inlet 204 (z=0) and proceeds through the single-phase flow section 212 as a sub-cooled fluid, and transitions to the multiphase flow section 214 when vaporization begins and exists the outlet 216 (z=L_{H}) as a two-phase mixture (or as a gas). In the multiphase flow section 214, the occupied volume and the velocity are functions of the vapor fraction. Thus, integrating the momentum equation (11) along the length of the conduit 210 for the two sections 212, 214, provides:

$$\begin{matrix}{( Δ {p}_{1 ϕ} )}_{H} = {p}_{in} - p ( λ ) = {\int }_{0}^{λ ( t )} [ \frac{f}{{D}_{H}} \frac{{G}^{2}}{2 {ρ}_{l}} + {ρ}_{l} g ] d z & ( 12 ) \\ {( Δ {p}_{2 ϕ} )}_{H} = p ( λ ) - {p}_{ex} = {\int }_{λ ( t )}^{L} [ \frac{f}{{D}_{H}} \frac{{G}^{2}}{2 〈 {ρ}_{h} 〉} + 〈 {ρ}_{h} 〉 g ] d z & ( 13 )\end{matrix}$$

where (Δp_{1,φ})_{H} is the pressure drop in the single-phase flow section 212; (Δp_{2φ})_{H} is the pressure drop in the multiphase flow section 214, and <ρₕ> is the average density in the multiphase flow section 214, which is a function of enthalpy (h) in the two-phase approximation. As will be appreciated, the kinetic term from the equation (11) may be neglected. Further, the total pressure drop remains constant (equation (7)). The total pressure drop remains constant; thus, applying the perturbation operation provides:

δΔp₁+δΔp₂=0 (14)

where δΔp₁ is the pressure drop perturbation in the single-phase flow section 212 and δΔp₂ is the pressure drop perturbation in the multiphase flow section 214.

Further, the four system variables identified above—velocity, density, enthalpy, and pressure—can be related to the perturbation as a sum of a steady function and a first-order linear perturbation. According, the four variables are expressed as:

u(t)=u₀+δu(t) (15)

ρ(t)=ρ₀+δρ(t) (16)

h(t)=h₀+δh(t) (17)

p(t)=p₀+δp(t) (18)

where the steady functions are the conservation equations in steady state. A Laplace transform can be employed to solve equations 15-18, which can then be employed by perturbing the equations 12 and 13 above. This leads to the perturbations in the single and multiphase flow sections 212, 214 being determined according to equations (19) and (20), respectively, as:

$$\begin{matrix} {δ ( Δ {\tilde{p}}_{1 ϕ} )}_{H} = ⌈ ( f \frac{{λ}_{0}}{{D}_{H}} ) {G}_{0} ⌉ δ {\tilde{u}}_{in} ( s ) + ( \frac{{G}_{0}^{2} f}{2 {ρ}_{l} {D}_{H}} + g {ρ}_{f} ) δ \tilde{λ} ( s ) & ( 19 ) \\ {δ ( Δ {\tilde{p}}_{2 ϕ} )}_{H} = {\int }_{{λ}_{0}}^{Lh} [ \frac{f}{{D}_{H}} {G}_{0} δ {\tilde{u}}_{in} ( s , z ) + ( \frac{f}{2 {D}_{H}} {u}_{0}^{2} + g ) δ \tilde{p} ( s , z ) ] d z - ( \frac{{G}_{0} {u}_{in 0} f}{{D}_{H}} + g {ρ}_{f} ) δ \tilde{λ} ( s ) & ( 20 )\end{matrix}$$

where s is the Laplace variable, ρ_{f} is the average density of the fluid.

The position λ of the interface between the multiphase flow section 214 and the single-phase flow section 212 may now be perturbed. In some real systems, for example, the boundary between the single-phase flow section 212 and the multiphase flow section 214 can be provided by the heating and evaporation of the liquid in the fluid conduit 210 and need not occur by injection of gas, as by the gas inlet 206. Substituting δλ and δu for λ and u, respectively, and using the conservation equations provides:

$$\begin{matrix}\frac{d δ \tilde{h}}{d z} + \frac{s}{{u}_{in 0}} δ \tilde{h} ( s , z ) = \frac{δ \tilde{ϕ}}{ρ {u}_{0}} - {ϕ}_{0} \frac{δ \tilde{u}}{ρ {u}_{0} {u}_{in 0}} \\ where & ( 21 ) \\ ϕ = \frac{{q}^{″} {P}_{H}}{A} & ( 22 )\end{matrix}$$

Where P_{H} is the perimeter of the pipe and A the outside area and q″ is the surface heat flux transferred to the fluid (in Watts) and thus can be expressed as:

q′=H_{1φ}(T_{w}−T_{B}) (23)

where T_{w} is the wall temperature and T_{B} is a reference temperature. When perturbation is applied, the surface heat flux becomes:

$$δ \tilde{q} = {H}_{1 ϕ} ( δ {\tilde{T}}_{w} - δ {\tilde{T}}_{B} ) + {q}_{0} a \frac{δ \tilde{ u}}{{u}_{in 0}} \qquad ( 24 )$$

where H is a convective thermal transfer coefficient that varies as a function of the fluid velocity inside the conduit 210. The convective thermal transfer coefficient H in the single-phase flow section 212, in turn, can be expressed as:

$${H}_{1 ϕ} = {{H}_{1 ϕ 0} [ \frac{{u}_{in} ( t )}{{u}_{in 0}} ]}^{a} \qquad ( 25 )$$

where a is generally chosen to be 0.8 according to the Colburn formula. Further, the temperatures in equation (23) can be written as:

$$\begin{matrix}δ {\tilde{T}}_{B} = \frac{δ \tilde{h}}{{c}_{pj}} & ( 26 ) \\ δ \tilde{T} w = {Z}_{1} ( s ) δ \tilde{q} \\ where & ( 27 ) \\ {Z}_{1} ( s ) = - \frac{A {P}_{H}}{{ρ}_{h} {c}_{ph} s} & ( 28 )\end{matrix}$$

and c_{pf} is the heat capacity of the fluid and A is the surface area of the pipe.

This allows a relationship between heat variation, enthalpy, and velocity of the fluid system, as:

$$δ \tilde{q} = \frac{{q}_{0} a}{1 - {H}_{1 ϕ} {Z}_{1} ( s )} \frac{δ \tilde{u}}{{u}_{0}} - \frac{{H}_{1 ϕ}}{{c}_{pf} ( 1 - {Z}_{1} ( s ) {H}_{1 ϕ} )} δ \tilde{h} \qquad ( 29 )$$

Therefore, equation (21) becomes:

$$\begin{matrix}\frac{d δ \tilde{h}}{d z} + β ( s ) δ \tilde{h} ( s , z ) = ϑ ( s ) \frac{δ \tilde{u}}{{u}_{in 0}} \\ where , & ( 30 ) \\ β ( s ) = \frac{s}{{u}_{in}} + \frac{{P}_{H} {H}_{1 ϕ 0}}{{G}_{0} {Ac}_{pf} ( 1 - {H}_{1 ϕ 0} {Z}_{1} ( s ) )} \\ and & ( 31 ) \\ ϑ ( s ) = \frac{{P}_{H} {q}_{0}^{″}}{{G}_{0} A} [ \frac{a}{1 - {H}_{1 ϕ 0} {Z}_{1} ( s )} - 1 ] & ( 32 )\end{matrix}$$

The differential equation (30) can be integrated between L=0 and L=λ₀, with the boundary condition being δ\tilde{h}=δ\tilde{h} at z=0. This yields:

$$δ \tilde{h} ( s , {λ}_{0} ) = δ {\tilde{h}}_{in} exp ( - β ( s ) {λ}_{0} ) + \frac{ϑ ( s )}{β ( s )} [ 1 - exp ( - β ( s ) {λ}_{0} ) ] \frac{δ \tilde{u}}{{u}_{in 0}} \qquad ( 33 )$$

When integrating equation (33) between λ₀ and λ(t), a perturbation of the length as a function of fluid enthalpy is determined as:

$$δ \tilde{λ} = - \frac{ρ u}{ϕ} δ \tilde{h} = - \frac{{λ}_{0}}{Δ {h}_{sub}} δ \tilde{h} \qquad ( 34 )$$

where Δh_{sub} is the sub-cooling enthalpy and corresponds to the difference between the enthalpy of the fluid at the inlet 204 and the enthalpy of saturated liquid for the same pressure. This gives a relation between δũ and δ\tilde{λ}.

Turning now to the mass conservation equation (9), and substituting Ω=∂u/∂z, the mass conservation becomes:

$$\frac{\partial ρ}{\partial t} + u \frac{\partial ρ}{\partial t} + ρΩ = 0 \qquad ( 35 )$$

Applying the perturbation operator yields:

$$\frac{d δ \tilde{ρ}}{d z} + ( \frac{\frac{s}{Ω} + 1}{( z - {λ}_{0} + \frac{{u}_{in 0}}{Ω} )} ) δ \tilde{ρ} = \frac{{G}_{0}}{{Ω}^{2}} [ \frac{δ \tilde{u}}{{( z - {λ}_{0} + \frac{{u}_{in 0}}{Ω} )}^{3}} - \frac{δ \tilde{Ω}}{{( z - {λ}_{0} + \frac{{u}_{in 0}}{Ω} )}^{2}} ] \qquad ( 36 )$$

In order to integrate equation (36), a boundary condition is needed. To obtain such a boundary condition, the original conservation equation (9) can be integrated between λ₀ and λ. This yields.

$${\int }_{{λ}_{0}}^{λ} \frac{\partial ρ}{\partial t} d z + ρ ( t , λ ) u ( t , λ ) - ρ ( t , {λ}_{0} ) u ( t , {λ}_{0} ) = 0 \qquad ( 37 )$$

Applying the perturbation and Laplace transform, equation (37) becomes:

$$δ \tilde{ρ} ( s , z ) = \frac{{ρ}_{f}}{{u}_{0}} ( δ {\tilde{u}}_{in} ( t ) - δ \tilde{u} ( s , {λ}_{0} ) ) \qquad ( 38 )$$

The velocity component of this equation can be eliminated by substituting the perturbed equation u=(z−λ)Ω+uᵢₙ. The following equation is thus obtained from equation (38):

$$δ \tilde{ρ} ( s , {λ}_{0} ) = \frac{{Ωρ}_{f}}{{u}_{0}} δ \tilde{λ} ( s ) \qquad ( 39 )$$

With an initial condition, for the change in density at λ₀, equation (39) can be integrated, as:

$$δ \tilde{ρ} ( s , z ) = [ {s ( \frac{{u}_{in}}{u ( z )} )}^{( \frac{s}{Ω} - 1 )} - Ω ] \frac{Ω {G}_{0}}{( s - Ω ) {u}^{2} ( z )} δ \tilde{λ} ( s ) + [ 1 - {( \frac{{u}_{in}}{u ( z )} )}^{( \frac{s}{Ω} - 1 )} ] \frac{Ω {G}_{0}}{( s - Ω ) {u ( z )}^{2}} δ {\tilde{u}}_{in} - [ 1 - {( \frac{{u}_{in}}{u ( z )} )}^{( \frac{s}{Ω} - 1 )} ] \frac{{G}_{0} {u}_{m}}{( s - Ω ) {u ( z )}^{2}} δ \tilde{Ω} ( s ) \qquad ( 40 )$$

The same equation is also integrated between λ₀ and L_{H} to determine the pressure drop in the multiphase flow section 214.

The velocity perturbation is calculated by applying a perturbation to the equation u=(z−λ)Ω+uᵢₙ;

δũ(s, z)=(z−λ₀)δ\tilde{Ω}(s, z)−Ω₀δ\tilde{λ}(s)+δũᵢₙ(s) (41)

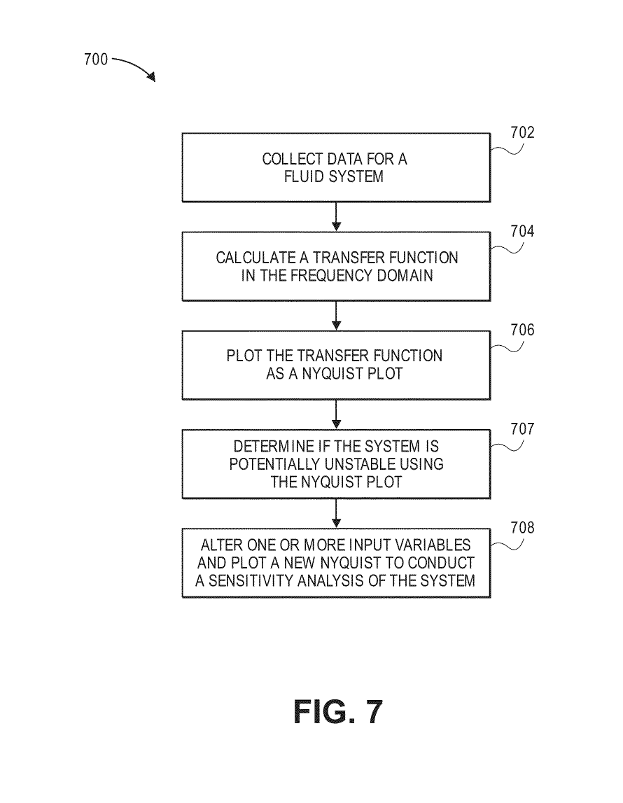

Further, a relationship can be established between Ω and the fluid enthalpy in the multiphase flow section 214. Using the linear model from the two-zones approximation shown in FIG. 6 provides that the specific volume is linearly correlated to the enthalpy, yielding:

$$Ω = ϕ \frac{{v}_{fg}}{{h}_{fg}} \qquad ( 42 )$$

where v_{fg} is the difference of specific volume between the inlet 204 and the outlet 216 and h_{fg} is the enthalpy difference between the same two points. Therefore, it is possible to write the pressure drop perturbation as a function of inlet velocity uᵢₙ (or mass flow), as:

δ(Δ\tilde{p}_{1φ})_{H}=Π₁(s)δũᵢₙ(s) (43)

δ(Δ\tilde{p}_{2φ})_{H}=Π₂(s)δũᵢₐ(s) (44)

where, for the single-phase flow section 212:

$$\begin{matrix}{Γ}_{1} ( s ) = {G}_{0} ( f \frac{{λ}_{0}}{{D}_{H}} + ( \frac{{fu}_{in}}{2 {D}_{H}} + \frac{g}{{u}_{in}} ) {Λ}_{1} ( s ) ) \\ and & ( 45 ) \\ {Λ}_{1} ( s ) = - \frac{{λ}_{0}}{Δ {h}_{sub} {u}_{in}} \frac{ϑ ( s )}{β ( s )} [ 1 - exp ( - β ( s ) {λ}_{0} ) ] & ( 46 )\end{matrix}$$

For the multiphase flow section 214:

$$\begin{matrix} {Π}_{1} ( s ) = {G}_{0} [ {F}_{1} ( s ) - {F}_{2} ( s ) {Λ}_{1} ( s ) ] \\ where & ( 47 ) \\ {F}_{1} ( s ) = \frac{f ( {L}_{H} - {λ}_{0} ) ( 2 s - Ω )}{2 {D}_{H} ( s - Ω )} + \frac{{fu}_{in}}{2 {D}_{H}} \frac{Ω}{( s - Ω ) ( s - 2 Ω )} ⌈ {( \frac{{u}_{in}}{{u}_{out}} )}^{\frac{s}{Ω} - 2} - 1 ⌉ + \frac{g}{{u}_{in}} \frac{1}{( s - Ω )} [ 1 - ( \frac{{u}_{in}}{{u}_{out}} ) ] & ( 48 ) \\ {F}_{2} ( s ) = \frac{f ( {L}_{H} - {λ}_{0} ) Ω ( 2 s - Ω )}{2 {D}_{H} ( s - Ω )} + \frac{{fu}_{in}}{2 {D}_{H}} \frac{Ω s}{( s - Ω ) ( s - 2 Ω )} ⌈ {( \frac{{u}_{in}}{{u}_{out}} )}^{\frac{s}{Ω} - 2} - 1 ⌉ + \frac{g}{{u}_{in}} \frac{Ω}{( s - Ω )} [ {( \frac{{u}_{in}}{{u}_{out}} )}^{\frac{s}{Ω}} - ( \frac{{u}_{in}}{{u}_{out}} ) ] + \frac{{fu}_{in}}{2 {D}_{H}} + \frac{g}{{u}_{in}} & ( 49 )\end{matrix}$$

and Δh_{sub} is the change in sub-cooling entropy (i.e., the entropy difference between a liquid and the entropy of the compressible mixture, in the illustrated two-zones model).

Accordingly, as shown, a transfer function relating the pressure drop perturbation to the velocity perturbation in the frequency domain is established, as at 102. Further, with the relationships between pressure and velocity perturbations known in each of the single and multiphase flow sections 212, 214, the method 100 may proceed to generating relationship between the velocity perturbation and the pressure perturbation for the combination of the single and multiphase flow sections 212, 214, using the first and second relationships established above, as at 106. In an embodiment, the overall relationship may be the summation of the first and second transfer functions. Accordingly, the relationship between the overall pressure perturbation and the overall velocity perturbation may be described as:

δ(Δ\tilde{p})=[Γ₁(s)°Π₁(s)]δũᵢₙ(s) (50)

which can be rearranged as:

δũᵢₙ(s)=[Γ₁(s)+Π₁(s)]⁻¹δ(Δ\tilde{p}) (51)

With the relationship between velocity perturbation and pressure perturbation in the frequency domain known, the method 100 may proceed to determining when the system 200 is potentially unstable, as at 108. Instability may occur when there is no causality between the velocity perturbation and the pressure perturbation. This happens, for example, when the transfer function from equation (52) is undefined, i.e., when:

Γ₁(s)+Π₁(s)=0 (52)

However, finding the roots of this equation may be complex and in some cases difficult to solve algebraically. Accordingly, a solution may be provided in the form of a Nyquist plot. As shown in FIGS. 6A and 6B, the real and imaginary portions of the transfer function are represented on the two axis. The stability of the system depends on the position of the function relative to the point (−1, 0). That is, in FIG. 6A, the plot 601 does not proceed around (−1, 0) and is therefore stable. On the other hand, the plot 602 of FIG. 6B does proceed around (−1, 0) and is, therefore, potentially unstable.

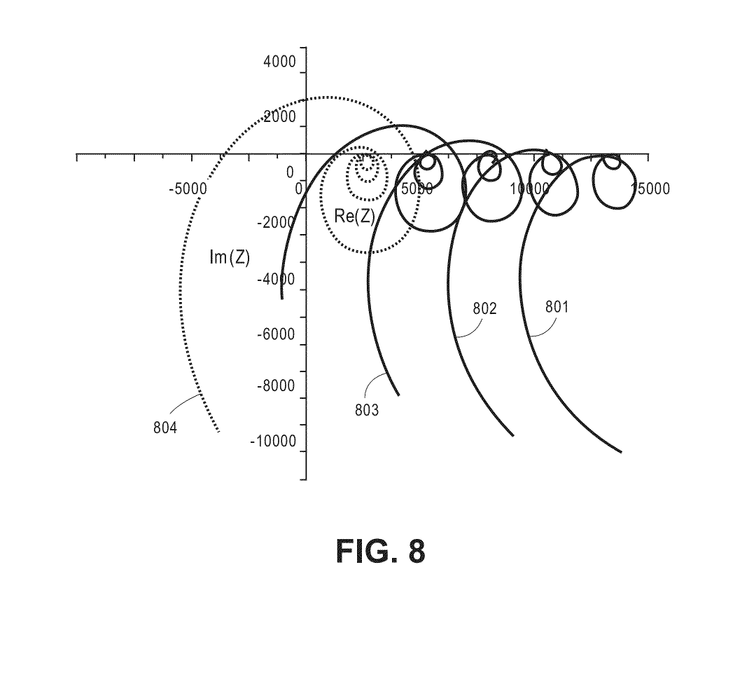

FIG. 7 illustrates a method 700 of modeling system stability sensitivity, according to an embodiment. The method 700 may begin by collecting data for the system, as at 702. The data collected may include pipe diameter and length, pressure at the outlet of the system, liquid density, gas density, mass flow rate, input power, sub-cooling enthalpy, inlet temperature, outlet temperature, enthalpy difference between the inlet and the outlet, friction coefficient, convective heat transfer coefficient, and specific heat.

Using this data, the method 700 can proceed to calculating the transfer function relating pressure perturbation and velocity perturbation for the system, as at 704. Such calculation can proceed by operation of at least part of one or more embodiments of the method 100 described above. With the transfer function determined, the transfer function can be plotted in a Nyquist plot, as at 706. The Nyquist plot can then be analyzed to determine if the system is unstable, as at 707.

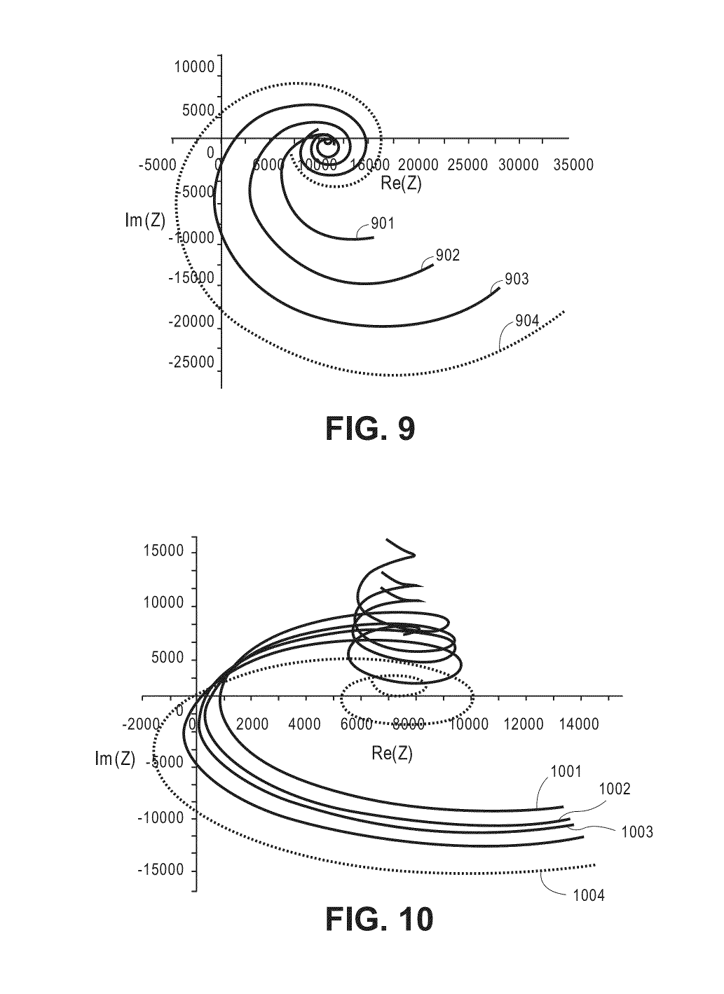

Moreover, the method 700 can include iteratively changing variables and plotting multiple Nyquist plots for the system, thereby performing a sensitivity analysis for one or more of the variables, as at 708. FIGS. 8-10 illustrate examples of such a sensitivity analysis. In FIG. 8, the velocity of a particular system is reduced, such that the system begins at Nyquist plot 801 and proceeds to Nyquist plots 802-804. The Nyquist plot 804 proceeds around the point (−1, 0), thus resulting in a potential for instability of the system at the operating characteristics (variables) provided. It will be appreciated that any step for changing velocity may be employed, and any number of Nyquist plots may be considered in performing such a sensitivity analysis.

FIG. 9 illustrates another type of sensitivity analysis, this time with the heat transfer rate to the system increasing. The analysis may begin with a relatively low heat transfer rate, which may generate the Nyquist plot 901. The heat transfer rate may then be increased incrementally, resulting in plots 902, 903, and 904. It will be appreciated that any step adjustment, whether uniform or non-uniform, and any number of plots may be employed in the sensitivity analysis. Once the plot 904 is reached, the sensitivity analysis may be terminated, as the system may be unstable under the conditions that result in plot 904.

FIG. 10 illustrates yet another type of sensitivity analysis, this time with sub cooling enthalpy decreasing. The analysis may begin with a relatively high sub-cooling enthalpy, resulting in Nyquist plot 1001. The sub cooling enthalpy may then decrease, e.g., incrementally, resulting in plots 1002, 1003, 1004, with plot 1004 indicating the potential for instability in the system. Decreasing sub-cooling enthalpy may have a complex effect on the system, at first decreasing stability and then, at some point, increasing stability.

Although the sensitivity analyses are illustrated by altering a single variable, it will be appreciated that multi-variable embodiments are contemplated. Furthermore, the sensitivity analysis can be visual, for example, by viewing multiple Nyquist plots, such as provided simultaneously or sequentially by a display in communication with a processor. In other embodiments, the Nyquist plots may be analyzed by the processor according to one or more algorithms without requiring visual determinations.

Such analysis can be visual, for example, by looking at a display of the Nyquist plot to determine if it proceeds around (−1, 0), or can be done automatically, using a processor. Furthermore, the method 700 can include altering one or more of fluid velocity (mass flow rate), heat transfer, and sub-cooling enthalpy to determine system sensitivity and/or the boundaries for stability in the system.

For example, as velocity decreases, the system trends toward potentially unstable conditions. This may follow because slower velocity provides for a larger multiphase flow section, as the liquid is heated and vaporization begins at a position closer to the inlet of the pipe. Since density wave oscillations may propagate only in the multiphase flow section (the liquid phase being considered incompressible), the system may tend to be less stable as the multiphase flow section length increases.

Such frequency domain approach, as described above, allows a consideration of many different cases and configurations of the system 200. Expanding upon the simplified, conceptual system 200 described above, more complex cases, including valves, elbows, parallel tubing, etc., as are commonly found in real-world applications, can be modeled. Accordingly, to model the

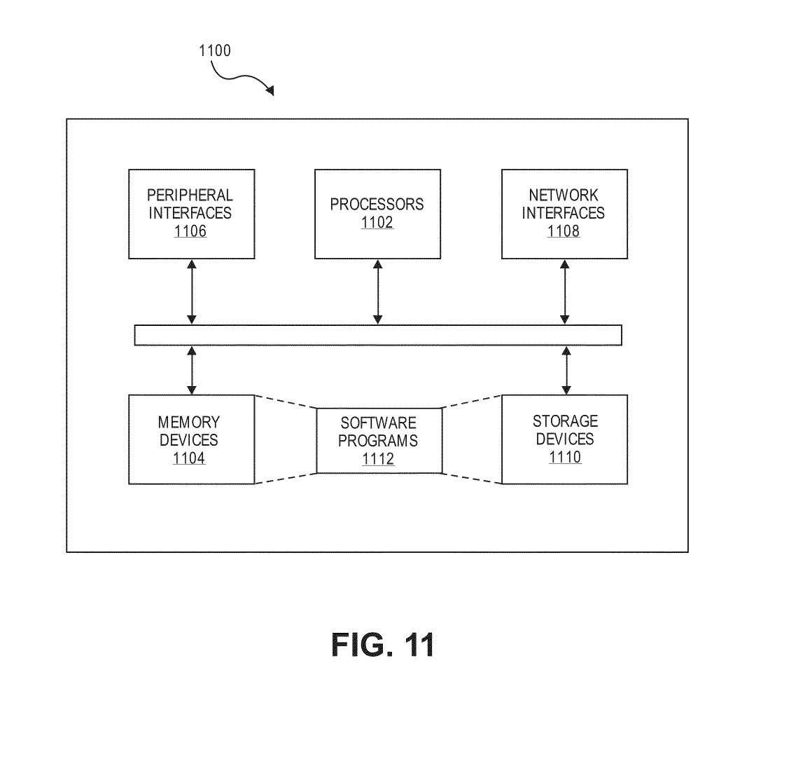

FIG. 11 illustrates a schematic of an embodiment of a computing system 1100 that may be used to carry out one or more portions of one or more embodiments of the method 200 and/or the method 700. The computing system 1100 can include one or more processors 1102 of varying core (including multi-core) configurations and clock frequencies. The one or more processors 1102 can be operable to execute instructions, apply logic, etc. It will be appreciated that these functions can be provided by multiple processors or multiple cores on a single chip operating in parallel and/or communicably linked together.

The computing system 1100 can also include one or more memory devices or computer-readable media 1104 of varying physical dimensions, accessibility, storage capacities, etc. such as flash drives, hard drives, random access memory, etc., for storing data, such as images, files, and program instructions for execution by the processor 1102. In an embodiment, the computer-readable media 1104 can store instructions that, when executed by the process, are configured to cause the computing system 1100 to perform operations. For example, execution of such instructions can cause the computing system 1100 to implement one or more portions and/or embodiments of the method 100 and/or 700 described above.

The computing system 1100 can also include one or more network interfaces 1106. The network interfaces 1106 can include any hardware, applications, and/or other software. Accordingly, the network interfaces 1106 can include Ethernet adapters, wireless transceivers, PCI interfaces, and/or serial network components, for communicating over wired or wireless media using protocols, such as Ethernet, wireless Ethernet, etc. The network interface 1106 can be employed to transfer information related to one or more aspects of the methods 100 and/or 700 discussed above.

The computing system 1100 can also include one or more peripheral interfaces 1108 for communication with one or more keyboards, mice, touchpads, sensors, other types of input and/or output peripherals, and/or the like. In some implementations, the components of computing system 1100 need not be enclosed within a single enclosure or even located in close proximity to one another, but in other implementations, the components and/or others can be provided in a single enclosure.

The memory devices 1104 can be physically or logically arranged or configured to store data on one or more storage devices 1110. The storage device 1110 can include one or more file systems or databases in any suitable format. The storage device 1110 can also include one or more software programs 1112, which can contain interpretable or executable instructions for performing one or more of the disclosed processes. In some embodiments, the software programs 1112 can include PIPESIM® or OLGA® or both. When requested by the processor 1102, one or more of the software programs 1112, or a portion thereof, can be loaded from the storage devices 1110 to the memory devices 1104 for execution by the processor 1102.

Those skilled in the art will appreciate that the above-described componentry is merely one example of a hardware configuration, as the computing system 1100 can include any type of hardware components, including any necessary accompanying firmware or software, for performing the disclosed implementations. The computing system 1100 can also be implemented in part or in whole by electronic circuit components or processors, such as application-specific integrated circuits (ASICs) or field-programmable gate arrays (FPGAs).

The foregoing description of the present disclosure, along with its associated embodiments, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments.

For example, the same techniques described herein with reference to the computing system 1100 may be used to execute programs according to instructions received from another program or from another computing system altogether. Similarly, commands may be received, executed, and their output returned entirely within the processing and/or memory of the computing system 1100. Accordingly, neither a visual interface command terminal nor any terminal at all is strictly necessary for performing the described embodiments.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents.

In the above description and in the below claims, unless specified otherwise, the term “execute” and its variants are to be interpreted as pertaining to any operation of program code or instructions on a device, whether compiled, interpreted, or run using other techniques. Also, in the claims, unless specified otherwise, the term “function” is to be interpreted as synonymous with “method,” and may include methods within program code, whether static or dynamic, and whether they return a value or not. The term “function” has been used in the claims solely to avoid ambiguity or conflict with the term “method,” the latter of which may be used to indicate the subject matter class of particular claims.

What is claimed is:

1. A computer-implemented method for detecting a potential for dynamic instability in a fluid system, comprising:
generating a first transfer function in a frequency domain, wherein the first transfer function relates a pressure drop perturbation to a fluid velocity perturbation in a single-phase flow section of the fluid system;
generating a second transfer function in the frequency domain, wherein the second transfer function relates a pressure drop perturbation to a fluid velocity perturbation in a multiphase flow section of the fluid system; and
determining, using a processor, that the fluid system is potentially unstable using a combination of the first and second transfer functions.

2. The method of claim 1, further comprising combining the first and second transfer functions to relate the fluid velocity perturbation to the pressure drop perturbation for the fluid system, wherein determining that the fluid system is potentially unstable comprises determining that a sum of the first and second transfer functions is equal to zero.

3. The method of claim 1, wherein determining that the fluid system is potentially unstable comprises plotting a Nyquist plot of a combination of the first and second transfer functions.

4. The method of claim 1, wherein the first transfer function is:
$$\begin{matrix}{Γ}_{1} ( s ) = {G}_{0} ( f \frac{{λ}_{0}}{{D}_{H}} + ( \frac{{fu}_{in}}{2 {D}_{H}} + \frac{g}{{u}_{in}} ) {Λ}_{1} ( s ) ) , \\ where \text{:} \\ {Λ}_{1} ( s ) = - \frac{{λ}_{0}}{Δ {h}_{sub} {u}_{in}} \frac{ϑ ( s )}{β ( s )} [ 1 - exp ( - β ( s ) {λ}_{0} ) ] , \\ β ( s ) = \frac{s}{{u}_{in}} + \frac{{P}_{H} {H}_{1 ϕ 0}}{{G}_{0} {Ac}_{pf} ( 1 - {H}_{1 ϕ 0} {Z}_{1} ( s ) )} , and \\ ϑ ( s ) = \frac{{P}_{H} {q}_{0}^{″}}{{G}_{0} A} [ \frac{a}{1 - {H}_{1 ϕ 0} {Z}_{1} ( s )} - 1 ] ,\end{matrix}$$
wherein s is a Laplace variable, G₀ is momentum; f is a coefficient of friction; λ₀ is a location of an interface between the single-phase flow section and the multiphase flow section; uᵢₙ is the fluid velocity at an inlet to the fluid system; g is the acceleration due to gravity; and D_{H} is the pipe inlet diameter; P_{H} is the pipe radial perimeter; H_{1φ0} is the convective thermal transfer coefficient at a reference velocity; A is The surface area of the pipe; a is about 0.8; Z₁(s) is equal to the sum of the first and second transfer functions.

5. The method of claim 4, wherein the second transfer function is Π₁(s)=G₀[F₁(s)−F₂(s)Λ₁(s)], where:
$${F}_{1} ( s ) = \frac{f ( {L}_{H} - {λ}_{0} ) ( 2 s - Ω )}{2 {D}_{H} ( s - Ω )} + \frac{{fu}_{in}}{2 {D}_{H}} \frac{Ω}{( s - Ω ) ( s - 2 Ω )} ⌈ {( \frac{{u}_{in}}{{u}_{out}} )}^{\frac{s}{Ω} - 2} - 1 ⌉ + \frac{g}{{u}_{in}} \frac{1}{( s - Ω )} [ 1 - ( \frac{{u}_{in}}{{u}_{out}} ) ] , \\ {F}_{2} ( s ) = \frac{f ( {L}_{H} - {λ}_{0} ) Ω ( 2 s - Ω )}{2 {D}_{H} ( s - Ω )} + \frac{{fu}_{in}}{2 {D}_{H}} \frac{Ω s}{( s - Ω ) ( s - 2 Ω )} ⌈ {( \frac{{u}_{in}}{{u}_{out}} )}^{\frac{s}{Ω} - 2} - 1 ⌉ + \frac{g}{{u}_{in}} \frac{Ω}{( s - Ω )} [ {( \frac{{u}_{in}}{{u}_{out}} )}^{\frac{s}{Ω}} - ( \frac{{u}_{in}}{{u}_{out}} ) ] + \frac{{fu}_{in}}{2 {D}_{H}} + \frac{g}{{u}_{in}} , and$$
$$Ω = ϕ \frac{{v}_{fg}}{{h}_{fg}} ,$$
wherein L_{H} is a length of the fluid system, uₒᵤₜ is fluid velocity at an outlet of the fluid system, v_{fg} is a difference of specific volume between the inlet and the outlet, and h_{fg} is the enthalpy difference between the inlet and the outlet.

6. The method of claim 5, wherein determining that the fluid system is potentially unstable using the combination of the first and second transfer functions comprises determining an overall transfer function, the overall transfer function being δũ(s)=[Γ₁(s)+Π₁(s)]⁻¹δ(Δ\tilde{p}).

7. A computing system for modeling a fluid system having a single-phase flow section and a multiphase flow section, the computing system comprising:
one or more processors; and
one or more computer readable media containing instructions that, when executed by the one or more processors, cause the system to perform operations comprising:
generating a first transfer function in a frequency domain, wherein the first transfer function relates a pressure drop perturbation to a fluid velocity perturbation in the single-phase flow section of the fluid system;
generating a second transfer function in the frequency domain, wherein the second transfer function relates a pressure drop perturbation to a fluid velocity perturbation in the multiphase flow section of the fluid system; and
determining that the fluid system is potentially unstable using a combination of the first and second transfer functions.

8. The system of claim 7, wherein the operations further comprise combining the first and second transfer functions to relate the fluid velocity perturbation to the pressure drop perturbation for the fluid system, wherein determining that the fluid system is potentially unstable comprises determining that a sum of the first and second transfer functions is equal to zero.

9. The system of claim 7, wherein determining that the fluid flow system is potentially unstable comprises plotting a Nyquist plot of a combination of the first and second transfer functions.

10. The system of claim 7, wherein the operations further comprise performing a sensitivity analysis for the fluid system, comprising:
varying one or more input parameters of the first transfer function, the second transfer function, or both to generate a plurality of system transfer functions; and
plotting a Nyquist plot for each of the plurality of system transfer functions.

11. The system of claim 10, further comprising a visual display coupled with the one or more processors, wherein the operations further comprise displaying the Nyquist plot for each of at least some of the plurality of transfer functions on the visual display.

12. The system of claim 10, wherein the first transfer function is:
$$\begin{matrix}{Γ}_{1} ( s ) = {G}_{0} ( f \frac{{λ}_{0}}{{D}_{H}} + ( \frac{{fu}_{in}}{2 {D}_{H}} + \frac{g}{{u}_{in}} ) {Λ}_{1} ( s ) ) , \\ where \text{:} \\ {Λ}_{1} ( s ) = - \frac{{λ}_{0}}{Δ {h}_{sub} {u}_{in}} \frac{ϑ ( s )}{β ( s )} [ 1 - exp ( - β ( s ) {λ}_{0} ) ] , \\ β ( s ) = \frac{s}{{u}_{in}} + \frac{{P}_{H} {H}_{1 ϕ 0}}{{G}_{0} {Ac}_{pf} ( 1 - {H}_{1 ϕ 0} {Z}_{1} ( s ) )} , and \\ ϑ ( s ) = \frac{{P}_{H} {q}_{0}^{″}}{{G}_{0} A} [ \frac{a}{1 - {H}_{1 ϕ 0} {Z}_{1} ( s )} - 1 ] ,\end{matrix}$$
wherein s is a Laplace variable, G₀ is momentum; f is a coefficient of friction; λ₀ is a location of an interface between the single-phase flow section and the multiphase flow section; uᵢₙ is the fluid velocity at an inlet to the fluid system; g is the acceleration due to gravity; and D_{H} is the pipe inlet diameter; P_{H} is the pipe radial perimeter; H_{1φ0} is the convective thermal transfer coefficient at a reference velocity; A is The surface area of the pipe; a is about 0.8; Z₁(s) is equal to the sum of the first and second transfer functions.

13. The system of claim 12, wherein the second transfer function is Π₁(s)=G₀[F₁(s)−F₂(s)Λ₁(s)], where:
$${F}_{1} ( s ) = \frac{f ( {L}_{H} - {λ}_{0} ) ( 2 s - Ω )}{2 {D}_{H} ( s - Ω )} + \frac{{fu}_{in}}{2 {D}_{H}} \frac{Ω}{( s - Ω ) ( s - 2 Ω )} ⌈ {( \frac{{u}_{in}}{{u}_{out}} )}^{\frac{s}{Ω} - 2} - 1 ⌉ + \frac{g}{{u}_{in}} \frac{1}{( s - Ω )} [ 1 - ( \frac{{u}_{in}}{{u}_{out}} ) ] , \\ {F}_{2} ( s ) = \frac{f ( {L}_{H} - {λ}_{0} ) Ω ( 2 s - Ω )}{2 {D}_{H} ( s - Ω )} + \frac{{fu}_{in}}{2 {D}_{H}} \frac{Ω s}{( s - Ω ) ( s - 2 Ω )} ⌈ {( \frac{{u}_{in}}{{u}_{out}} )}^{\frac{s}{Ω} - 2} - 1 ⌉ + \frac{g}{{u}_{in}} \frac{Ω}{( s - Ω )} [ {( \frac{{u}_{in}}{{u}_{out}} )}^{\frac{s}{Ω}} - ( \frac{{u}_{in}}{{u}_{out}} ) ] + \frac{{fu}_{in}}{2 {D}_{H}} + \frac{g}{{u}_{in}} , and$$
$$Ω = ϕ \frac{{v}_{fg}}{{h}_{fg}} ,$$
wherein L_{H} is a length of the fluid system, uₒᵤₜ is fluid velocity at an outlet of the fluid system, v_{fg} is the change in specific volume between an inlet of the fluid system and an outlet of the fluid system; h_{fg} is an enthalpy difference between the inlet and the outlet, φ is heat transfer rate.

14. The system of claim 13, wherein determining that the fluid system is potentially unstable using the combination of the first and second transfer functions comprises determining an overall transfer function, the overall transfer function being δũᵢₙ(s)=[Γ₁(s)+Π₁(s)]⁻¹δ(Δ\tilde{p}).

15. The system of claim 7, wherein the fluid system comprises a casing head, an artificial lift system, an annulus of a wellbore, or a combination thereof.

16. A computer-readable medium storing instructions that, when executed, are configured to cause a computing system to perform operations, the operations comprising:
collecting data for one or more variables of a fluid system;
generating a transfer function in a frequency domain using the data collected, wherein the transfer function relates a pressure drop perturbation to a fluid velocity perturbation in the fluid system; and
determining, using a processor, that the fluid system is potentially unstable using the transfer function.

17. The computer-readable medium of claim 16, wherein determining that the fluid system is potentially unstable comprises plotting the transfer function using a Nyquist plot.

18. The computer-readable medium of claim 17, wherein determining the fluid system is potentially unstable comprises determining that the Nyquist plot proceeds around a point (−1, 0).

19. The computer-readable medium of claim 16, wherein:
generating the transfer function comprises:
generating a first transfer function for a single-phase flow section of the fluid system, wherein the first transfer function relates a pressure drop perturbation to a fluid velocity perturbation in the frequency domain in the single-phase flow section; and
generating a second transfer function for a multiphase flow section of the fluid system, wherein the second transfer function relates a pressure drop perturbation to a fluid velocity perturbation in the frequency domain in the multiphase flow section; and
determining that the fluid system is potentially unstable using the transfer function comprises determining that the first and second transfer functions lack a causal relationship.

20. The computer-readable medium of claim 16, wherein the operations further comprise:
altering at least one of the one or more variables of the fluid system;
re-generating the transfer function using the at least one of the one or more variables that has been altered;
plotting a new Nyquist plot using the re-generated transfer function; and
comparing the new Nyquist plot to the Nyquist plot to determine a system sensitivity to the alteration of the at least one of the one or more variables.
